(19) United States
(12) Patent Application Publication
(10) Pub. No.: US 2018/0165986 A1
(43) Pub. Date: Jun. 14, 2018

(54) Real Time Phonetic Learning System

(71) Applicant: Unnati Patel, Irvine, CA (US)

(72) Inventor: Unnati Patel, Irvine, CA (US)

(21) Appl. No.: 15/464,530

(22) Filed: Mar. 21, 2017

Related U.S. Application Data
(60) Provisional application No. 62/432,696, filed on Dec. 12, 2016.

(51) Int. Cl. G09B 19/06; G10L 13/08; G06F 17/27; G06F 17/28; G09B 17/00

(52) U.S. Cl. CPC G09B 19/06; G10L 13/08; G09B 17/006; G06F 17/289; G06F 17/2735

(57) ABSTRACT

Phonetic method and apparatus for comprehensive language education through the use of physical tokens each encoding a respective character, e.g., alphabetical blocks, a corresponding baseboard, and a vocal output system. Each block's unique identifier leads to sounding of the appropriate pronunciation of the combination of letters placed on the baseboard, by using a microprocessor that interprets each block's positioning to form a phonetic sound representing the word, and playing resulting sound via speaker attached to the baseboard. Aspects support usage in a group setting like a classroom, with multiple baseboards connected to a central computer that monitors each user's activity related to block placements, which is visually depicted on a screen to the teacher, who can see what changes students are making on the baseboard in real time.

### RELATED APPLICATIONS

The present application claims the benefit and priority of U.S. Provisional Application No. 62/432,696, entitled “Phonetic method and apparatus for teaching/learning reading and pronunciation in real-time, that supports a connected learning environment,” filed on Dec. 12, 2016, which is hereby incorporated by reference.

### TECHNICAL FIELD

The present disclosure is directed to instructional devices for use in language learning, in particular for learning word spelling, the connection between the characters of a language, and their phonetic pronunciation when combined into words. Aspects are directed to what may be termed educational toys, although the use of the invention described herein is not limited to children.

### BACKGROUND

Pre-emergent readers of a language need to learn and recognize the relationship between letters and their associated phonetic sounds. Understanding this relationship helps readers gain facility in understanding the relationship between written texts and spoken language, and to properly pronounce and spell words. It can be helpful for a language learner to use a device which lets him hear the pronunciation of letters chosen by him.

Sounding out of individual letters and letter combinations is a very common way of teaching reading to young children. Teachers will often direct students to break down words and sound out smaller letter combinations. For example, when pronouncing the word ‘Chat”, the student is expected to say ‘C’ and ‘H’ make the sound ‘Cha’ and ‘A’ and ‘T’ make the sound ‘aat’ and when combined the word is pronounced ‘Chaat’.

There are approximately 44 unique phonemes that are used to pronounce a majority of the words in the spoken language. A phoneme is a single “unit” of sound that has meaning in a given language. As there are only 26 letters in the English language, sometimes letter combinations are used to make a phoneme. Additionally, a same letter can represent different phonemes. Thus, phonemic awareness may be a useful pre-requisite to reading.

Studies have shown that the level of phonemic awareness that children possess when first beginning to read and their knowledge of letters are the two best predictors of how well they will learn to read during the first two years of formal education. Other studies have shown that before a child learns to read, they must understand that the sounds that are paired with the letters are the same as the sounds of speech they hear every day.

Phonemic awareness is the understanding that words are made up of phonemes or individual units of sound that determine its meaning. For example, the word “bat” is made up of three individual phonemes: /b/ /a/ /t/. If, however, a phoneme is changed, the meaning of the word changes. For example, /b/ can be replaced by /m/ and the word becomes /m/ /a/ /t/.

Studies have found that introducing the children to the sounds of letters and letter combinations at an early age is a strong determinant of their reading skills as the same letter combination can represent different phonemes as in the example below (see: http://www.phonemicchart.com/what/).

chef=/∫ ef/choir

choir=/kwar [symbol] /

cheese=/t∫i:z/

The“ch” letter combination has three different pronunciations, which are represented by three different phonemes: /f/, /k/ and /if/.

Young children benefit from being taught that words are made up of small units and they need to build the ability to break down, manipulate and combine phonemes. It is common practice for teachers and other educators to ask children to “sound out” the letters and letter combinations when beginning reading instruction. There is a need to provide younger children and pre-emergent readers exposure to this phonemic awareness which will then form a solid foundation for their future reading skills and ability to comprehend what they are reading, especially for younger users, e.g., those in or around their first couple of years of formal education.

### SUMMARY

Aspects of this invention are directed to aiding users, for example young children, in the process of learning to read by providing an option of an apparatus that young children are familiar with such as the cube shaped blocks as shown in FIG. 2. The nature of the present system and method also lends itself to be a useful tool for aid in learning a new language for both older children and adults. It can aid in learning both spelling and pronunciation of words in a new language. The ability to get real-time feedback on pronunciation helps users gain confidence for conversation in the given language.

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

A particular embodiment is directed to an apparatus to aid in language and spelling skills, comprising a plurality of physical tokens sized and configured for individual manual manipulation by a user and each corresponding to one or more characters of an alphabet of a language, wherein each physical token comprises a plurality of facets, wherein one or more facets of each physical token is inscribed with the respective one or more characters corresponding to said physical token, and wherein each physical token encodes a decodable identification code unique to the respective one or more characters associated with said physical token; a processing unit comprising an electrical power source, a microprocessor, a speech synthesizer, a data storage unit, and an audio speaker; and a baseboard comprising a plurality of sequentially ordered token receptacles, each receptacle sized and configured to couple to any one of said physical tokens, wherein each receptacle comprises one or more sensors by which the identification code of said physical token may be decoded, wherein each sensor is in communication with said microprocessor and transmits to said microprocessor a signal indicative of said identification code of a physical token inserted into said receptacle, and wherein said microprocessor is configured and arranged to determine an ordered combination of characters corresponding to respective physical tokens coupled to the respective token receptacles, and further to generate an audio signal representing a phonetic pronunciation corresponding to said combination of characters.

A particular embodiment is directed to a system for instructing language and spelling skills, comprising a first learning aid having a processing unit, a communication unit and a baseboard including a plurality of sequential token receptacles, each token receptacle sized and configured to couple to a physical token encoding one of a plurality of characters in a language; a second learning aid, similarly constructed as said first learning aid, wherein each of said first and second learning aids are connectable through their respective communication units to a network, and wherein a server coupled to said network receives data over said network from each of said first and second learning aids indicative of placement of physical tokens into token receptacles of said first and second learning aids such that said server provides data to a supervisory user regarding a language or spelling activity by users of said first and second learning aids.

This overview is intended to provide an overview of subject matter of the present patent application. It is not intended to provide an exclusive or exhaustive explanation of the invention. Further limitations and disadvantages of conventional and traditional approaches will become apparent to one of skill in the art, through comparison of such systems with some aspects of the present invention as set forth in the remainder of the present application with reference to the drawings.

### BRIEF DESCRIPTION OF THE DRAWINGS

For a fuller understanding of the nature and advantages of the present invention, reference is made to the following detailed description of preferred embodiments and in connection with the accompanying drawings, in which:

FIG. 1 is a top view of an exemplary baseboard apparatus that may include a plurality of slots to receive blocks, a processing unit configured to analyze the signals sent from the slots and to synthesize speech based on such signals, and a speaker through which such synthesized speech is sounded, in accordance with some embodiments of the disclosure provided herein;

FIG. 2 is a perspective view of exemplary blocks, each representing an individual letter or combination of letters, to be used with the baseboard apparatus illustrated in FIG. 1, in accordance with some embodiments of the disclosure provided herein;

FIG. 3 is a top view of the baseboard apparatus of FIG. 1, wherein blocks have been inserted into the slots in order to form a word, which word is output through the speaker, in accordance with some embodiments of the disclosure provided herein;

FIGS. 4 and 5 are an exemplary flow chart illustrating the process followed by the processing unit of the baseboard apparatus of FIGS. 1 and 3 in response to actions by the user, in accordance with an embodiment of the disclosure provided herein;

FIG. 6 is a schematic diagram illustrating the components of a baseboard unit, in accordance with some embodiments of the disclosure provided herein;

FIG. 7 is a diagram illustrating an embodiment of the invention, in which a plurality of baseboard units are used by different users, e.g. students, wherein each of the units is in communication with a central computer, wherein such central computer is in communication with a visual display, e.g. for use by a teacher, that displays information regarding the actions of the various users of the baseboard units, in accordance with some embodiments of the disclosure provided herein; and

FIG. 8 is a diagram illustrating the use of multiple baseboard units in a classroom setting, with each baseboard unit in communication with a teacher's computing device, in accordance with some embodiments of the disclosure provided herein.

### DETAILED DESCRIPTION

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the preceding in view of the drawings where applicable.

Aspects of the technology described herein are explained in the context of English language learning, but it should be appreciated that the technology described herein is useful for and may be applied in any language and with any alphabet, including those that read right-to-left such as Hebrew and Arabic and those that read vertically.

The disclosure herein is directed to a phonetic method and apparatus for comprehensive language education. Particular emphasis is placed on reading, pronunciation, spelling and vocabulary through the use of alphabetical blocks, a corresponding baseboard, and a vocal output system for reinforcement learning. Each alphabet block (A through Z for example) will have a unique identifier that when used in combination on the baseboard leads to sounding of the appropriate pronunciation of the combination of letters. When placed next to other blocks on the baseboard, the unique identification code on each block makes it possible to be identified as a unique sequence, by using a microprocessor that interprets each block's spatial positioning. Each unique sequence is then parsed using an efficient text-to-speech algorithm to form a phonetic sound representing the word being formed with the blocks on the baseboard. The algorithm outputs its results as a sound file, which is then played via speaker attached to the baseboard. In addition, as the sequence of blocks is changed, a unique sequence is generated in real time which provides the user instant feedback on the pronunciation of the word being generated. Additionally, in some embodiments of the invention, the device can provide upon request dictionary-based meanings for the words being created, and also be used to test spelling skills with real-time feedback.

In addition to being a stand-alone apparatus utilized by a student, this device supports usage in a group setting like a classroom. Each baseboard manufactured has a unique baseboard ID that enables multiple baseboards to be connected to a central computer for data transfer and acknowledgment, such as in a classroom environment. The central computer monitors each user's activity related to block placements and the resulting word that has been spelled. The transmission to the central computer can take place either over a wire or wirelessly. The central computer can be a physical computer located locally, such as in a classroom, or could be hosted remotely and accessed using internet or proprietary protocols. The central computer captures a real-time record of user inputs. User inputs are visually depicted to the teacher either on a computer monitor or on a handheld mobile device like a tablet/smartphone using a web interface that connects to the central computer. The teacher's report intuitively shows how each of the students spelled the words and which students got it wrong or correct. The interface has the ability to disclose additional details such as time taken by each student and number of block movements by each user. The interface makes it possible for a teacher to notify students that got it wrong if they want to try for the second time. The teacher can see on the monitor what changes the student is making on the baseboard in real time. This invention thus makes a new teaching method possible by utilizing a connected learning apparatus that provides a real-time feedback on individual student actions. It is also a unique and efficient way for a teacher to understand each student's strengths and weaknesses in spelling phonetical words, not just on an absolute basis, but also relative to other students in class, and to conduct examinations. Finally, the central computer contains a database that maintains a record of activity to help monitor each user's progression.

In some embodiments, the device is able to play over the speaker the pronunciation of words or other sounds sent to the device from an external source, such as by a teacher in a classroom setting. Such sounds can be formed from text input using the device's text-to-speech algorithms, or could be transmitted to the device as pre-recorded sound files, for instance in the teacher's voice. Thus, for example, a teacher could send a pre-recorded list of words to the students in the classroom, instructing each student to hear the words and spell them using the blocks on their baseboard, with the resulting student actions visible to the teacher on his computer. In some embodiments, the device can interface with peripheral “modules” that provide spoken words played over the speaker for the user to attempt to spell using the blocks and the baseboard. A module could be in the form of a software program that is loaded onto the baseboard and run by the microprocessor in the baseboard. A module could be in the form a peripheral device that is connected to the baseboard, including by a wireless connection; such device could be a stand-alone device or an external computer. A module could also be a software program hosted on a remote computer that is accessed by the baseboard using proprietary or internet protocols.

One such module is a “quiz” or “language instructor” module, whereby the user is instructed by audio to spell a certain word, or to create a word corresponding to a picture that is shown to the user, or to create a word or words rhyming with a given word or with one another, and the device then verifies whether the user has placed the appropriate blocks on the baseboard corresponding to an appropriate word or words and/or a legitimate spelling of the word or words, and notifies the user of the results by playing an appropriate sound over the speaker. The user can elect to receive such feedback after submitting his attempt at spelling the work, such as by pushing a “submit” or similar button on the baseboard unit, or he can elect to receive real-time error notification while the blocks are being placed, i.e. each time a block is placed, for a more engaging instant feedback experience. This module can also incorporate a timer and associated feedback so that the user can complete the task within a certain timeframe.

Another such instructional module is a “sound manipulation” module, whereby the user is instructed to use the blocks to manipulate either beginning, middle or end sounds to teach alliteration, sound isolation and substitution, and thereby gain greater facility with the language. In yet another instructional module, which can be combined with the preceding module, the user is instructed to manipulate digraphs.

Another such module is a “game” module, allowing 2 or more baseboard users to interact with each other, through a wired or wireless connection. This module picks a word at random and announces it over the speakers on the baseboards; the users would then compete to be the first to spell the word correctly by placing the appropriate blocks on their respective baseboards.

This invention helps pre-emergent readers understand and recognize the relationship between letters and associated phonetic sounds when used in combination. The invention can help users get comfortable with the medium of learning to read and can aid in pronunciation through use of phonics. Inventions already exist that sound out the pronunciation of individual letters; however, the present invention is also for sounding out the pronunciation of combinations of letters. For example, when ‘T’ is placed on an empty board it will say “Ta”. When ‘H’ is placed on the right side, the speaker would sound out ‘Th’, and if an ‘E’ is added to the far right, it would sound out the word ‘The’, and so on as letters continue to be added to form different words. The tactile nature of the cube-shaped alphabetical blocks makes them suitable for infants, toddlers and young children. The invention is not only limited to use of cube shaped blocks as identifiers but can also be used with interchangeable identifier forms to help with reading and pronunciation for an older user or a user that is not familiar with the language being taught. Each of the 26 letters of the English language will have an individual block with a unique identifier (Additional letter blocks can be added to the set as needed). Each block will provide the user with a tactile object which is clearly marked with the appropriate letter and can be used as a reference for the associated sound. Once a block is placed on the first slot of the board, a sound will be generated in real time associated with the phonetic pronunciation of that letter. When a second letter is added to slot 2 of the board a corresponding sound will be generated representing the phonetic pronunciation of that 2-letter combination. In some embodiments, if the letter combination is not commonly used in the English language, such as ‘FP’, an error sound would be generated. The user will have the ability to continue to add letters within the slots provided on the board and corresponding sounds would be generated, teaching the user the appropriate pronunciation of the words. This invention thus provides a solid precursor for complete reading ability in a given language. The tactile nature of the invention also makes it very suitable for young learners and encourages learning through experimentation. The invention can also be used by adults trying to learn an unfamiliar language, and can aid in gaining confidence in pronunciation. Finally, in some embodiments of the invention, users can request the dictionary meaning of the formed word to improve understanding and seek to be tested in their ability to spell words; if the letters placed by the user do not form a dictionary-accepted word, an appropriate error sound is generated, thus helping the user learn awareness of words that are dictionary-accepted.

In some embodiments of the invention, the invention can be used for language conversion and translation, whereby the blocks are in one language and the corresponding voice output provides the pronunciation of the translation into another language of the word formed on the baseboard. Thus the invention can be used as a means of learning vocabulary and pronunciation in a new language.

The aspects and embodiments described above, as well as additional aspects and embodiments, are described further below. These aspects and/or embodiments may be used individually, all together, or in any combination of two or more, as the technology described herein is not limited in this respect.

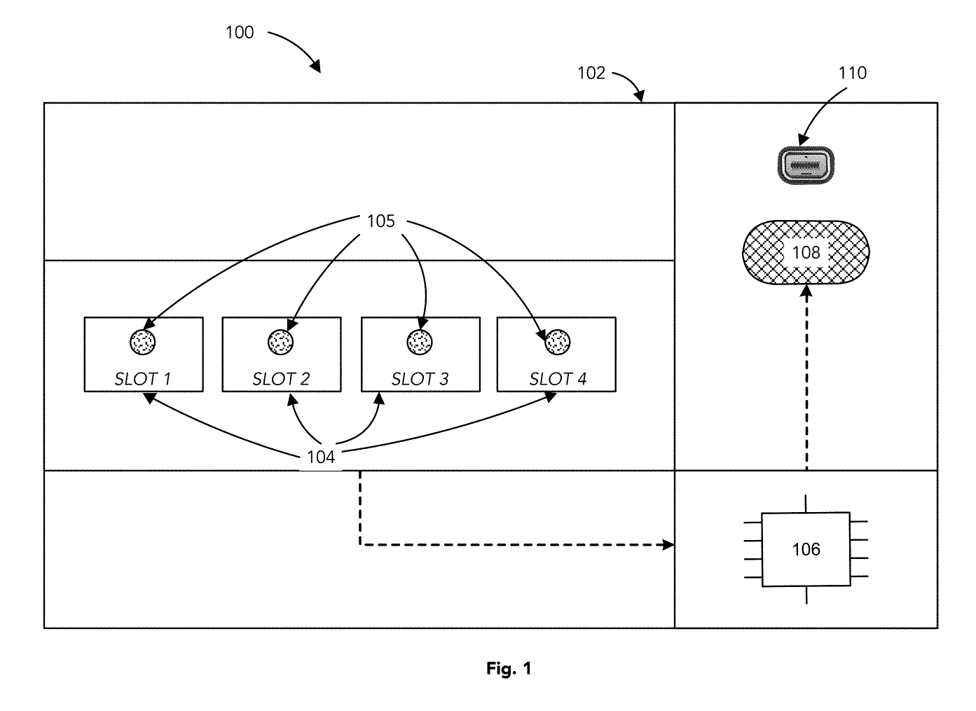

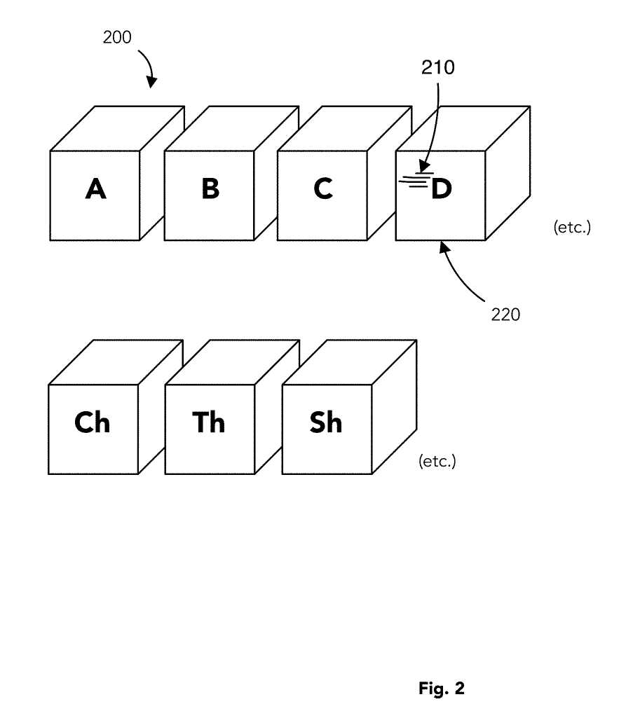

FIG. 1 illustrates a top view of an example of a baseboard unit 100 in an embodiment of the invention for implementing a language and spelling learning aid. The unit comprises a housing 102, into which are disposed a plurality of slots 104, each of which is sized and configured to accept any one of the various blocks, illustrated in FIG. 2, representing a letter or combination of letters.

It is to be understood that the “blocks” of the present (and other) embodiments are merely illustrative examples of a more general physical token, which can take on many more physical forms than blocks. Blocks and other objects of different shapes (e.g. rectangular, cylindrical, flat cards, sticks, rings, or spheres) or other physical tokens are all to be taken as falling within the framework of the present disclosure, commonly illustrated and described using “blocks”. But cube-shaped blocks referred to herein are an example of physical tokens and are not intended to be limiting of the invention.

More generally, characters, icons or other units of spelling or linguistic elements, including letters of the alphabet, compound letter groups, numbers, etc., can be represented on the physical token, but these are referred to herein as “letters” or as “characters” for simplicity.

In one or more illustrated examples of the disclosure herein, four token receptacles, apertures, or slots are shown, such as in FIG. 1, but a greater or lesser number of slots could be used in other embodiments of the invention. In general, the token receptacles 104 can accept and couple to at least a portion of a physical token (described further herein), and sensors 105 are associated with each token receptacle 104. Each sensor 105 can sense a physical token coupled to or inserted into the respective token receptacle 104, and each sensor 105 can read from the physical token an identifier of the token. The token identifier represents a character of the language as encoded in or on the physical token.

In one example, a painted, printed or encoded letter of the alphabet may be associated with a physical token in the form resembling a child's toy building block, and an encoded identifier in the block can identify a given block with the corresponding letter on that block as will be illustrated below. The baseboard 100 has a plurality of such token receptacles 104, which are generally arranged in a sequence. For example, the token receptacles may be disposed in the face of the baseboard along a straight line from left to right, up to down, in a Cartesian grid, or in another sequential/ordered configuration. This sequential configuration gives the user an ordered arrangement for inserting the physical tokens into the baseboard, one into each token receptacle, e.g., spelling a word out of several individual characters or letters, as will be shown in the examples below.

The unit 100 further comprises a microprocessor 106 in its housing, which acts as or with a speech synthesizer or other audio generator to produce a sound (e.g., phonetic sound) corresponding to the one or more physical tokens inserted into the token receptacles, and according to an order in which they are so placed. A loudspeaker 108 is incorporated into or with the apparatus 100 through which the apparatus pronounces words or other letter combinations represented by the blocks present in the slots. Each slot 104 is equipped with a sensor 105 which is configured to read the identification code of any block properly placed in such slot, thereby identifying the letter or letter combination represented by such block, and to transmit such code to the microprocessor 106. One or more audio jacks 110 for delivering an electrical audio signal to external speakers or earphones, and/or for attachment of an external microphone, are present in some embodiments. In some embodiments a microphone may be internal to the housing 102, similar to the speaker 108.

FIG. 2 illustrates a perspective view of exemplary physical tokens. In this example, the physical tokens are in the form of blocks 200 for use with the baseboard unit 100 of FIG. 1, and which fit onto or into token receptacle slots 104, described above. The blocks as shown are cuboid in shape in this example, although other shapes are possible, and the disclosure herein contemplates any physical representations of letters or letter combinations, beyond “blocks” as such, depending on the needs of the end user and the appropriateness of the language being taught. In an example, each block 200 has a front face 210 on which the letter corresponding to the block is clearly displayed. Each block also has a bottom face 220 containing an identification code uniquely identifying the letter represented by the block, which code can be read by the sensors 105 of FIG. 1. In some embodiments, other faces of the block may display the letter, or alternate forms of the letter, for example lower- and upper-case forms, or symbols or other information, such as transliteration or pronunciation, relating to the letter. In some embodiments, common letter combinations such as Ch or Th or Sh may be represented on a single block, in addition to the blocks containing each individual letter of the alphabet; each such combination would have a unique identification code corresponding to it. Such combinations can help the user build longer words. When a block is placed in the correct orientation in one of the slots, the sensors and the microprocessor identify the letter(s) corresponding to the block and its spatial position, and an appropriate audio sound is generated through the speaker. As block letters are added to the baseboard in sequence, the sensors and microprocessor will identify each combination through each block's spatial positioning. Each unique sequence is then parsed using an efficient text-to-speech algorithm to generate the phonetic sound representing the words being formed by the block letters. The algorithm outputs its results as a sound file, which is then played via the speaker.

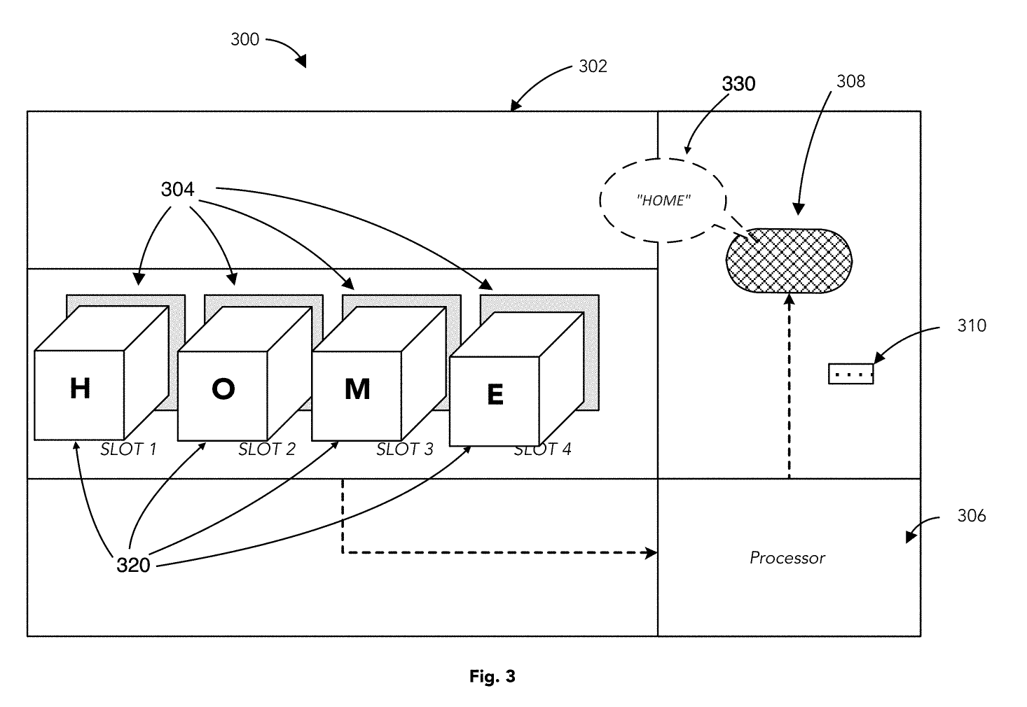

FIG. 3 illustrates a top view of the baseboard unit of FIG. 1 with physical tokens 320, for example encoded alphabet blocks, loaded into the token receptacle slots 304 in the face of the baseboard. The baseboard unit 300 comprises a housing 302, a plurality of token receptacle slots 304, a microprocessor 306 and a loudspeaker 308, as well as earphone and microphone jacks 310 as described earlier. Blocks 320 have been placed into the slots 304, with the blocks forming the word “HOME”. The sound 330 of the word “HOME” is produced from the built-in speaker 308 or through audio jack 310 to a corresponding external speaker or earphones.

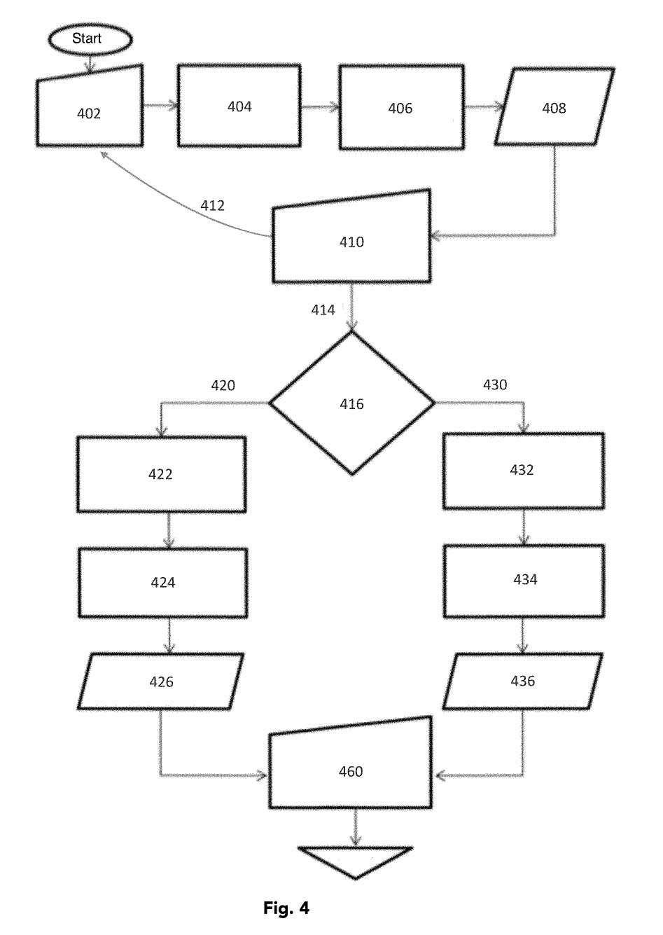

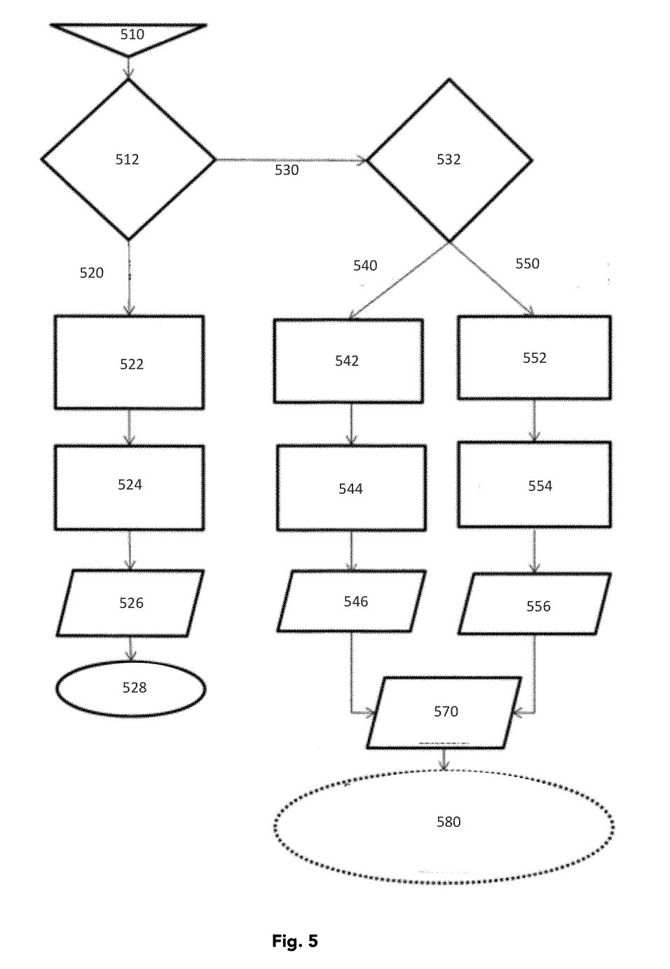

FIGS. 4 and 5 represent an exemplary flowchart, depicted in two parts on the two sheets for convenience, illustrating exemplary logic followed by the microprocessor 306 in responding to user inputs, i.e. actions by the user in adding blocks to or removing blocks from the baseboard. This arrangement of steps is given by way of example, and other ordering of the steps, as well as examples having fewer or more steps, are also contemplated hereunder. At the beginning state 402 there are no blocks on the baseboard. At step 404 a block has been placed on the baseboard, representing a letter [Chart ], and the sensor in the slot containing the block reads the block's identification code and transmits such code to the microprocessor. At step 406 the microprocessor generates the appropriate phonetic sound corresponding to [Chart]. In some embodiments this sound is generated using a voice algorithm; in other embodiments this sound is retrieved from a collection of pre-recorded sounds stored in non-volatile memory connected to the microprocessor; in other embodiments this sound is retrieved using the microprocessor's wireless interface from a collection of pre-recorded sounds stored on a remote server using an internet protocol; in other embodiments this sound is retrieved using the microprocessor's Bluetooth™ or other wireless interface from a collection of pre-recorded sounds on a paired smartphone or tablet computer running an app that supports such communication. In step 408 the sound is transmitted to and played on the loudspeaker.

At step 410 the system is awaiting further input, which could be in the form of either an addition of a block to, or the removal of a block from, the baseboard. If a block is removed, left branch 412 is followed, returning the system to step 402, where there are no blocks on the baseboard and the system is awaiting further input. If, on the other hand, a new block is added, down branch 414 is followed, and now the baseboard contains 2 blocks, the new block and the existing block. At step 416 the microprocessor determines the position of the new block on the baseboard. If the new block is in the slot immediately to the left of the existing block, then left branch 420 is followed. If the new block is in the slot immediately to the right of the existing block, then right branch 430 is followed. If the new block is in a slot not adjacent to the existing block, then there is a gap between blocks on the baseboard. Branches 420 and 430 assume no gaps between blocks. In the case where there is a gap between blocks, in some embodiments the system will generate a sound as an error code; in other embodiments the system will generate and play over the loudspeaker the sounds corresponding to each of the blocks on the baseboard, possibly with a pause in between sounds, and possibly with an error code sound in addition to the phonetic sounds of the letter. In some embodiments the user may be able to instruct the device as to which of the foregoing outcomes will result when there is a gap between blocks on the baseboard.

If branch 420 is followed, the system next reaches step 422, where the sensors determine which letters, [Char2] and [Char1], are represented by the blocks on the baseboard, and transmits this sequence to the microprocessor. At step 424 the microprocessor generates the phonetic sound corresponding to the compound two-character sequence [Char2][Char1], using a voice algorithm and/or using sounds stored in memory. This phonetic sound is played on the loudspeaker at step 426.

If branch 430 is followed, then a set of steps is followed at steps 432, 434 and 436 that are identical to those followed at steps 422, 424 and 426, except that the relevant letter sequence is [Char1][Char2] rather than [Char2][Char1]. Whether branch 420 or branch 430 is followed, the system next reaches step 460, in which there are 2 blocks on the baseboard and the system is awaiting the next action by the user.

The flowchart continues at step 510 of FIG. 5, where there are 2 blocks on the baseboard. It is assumed, without loss of generality, that the blocks are [Char1][Char2], adjacent to each other and in that order. The next step 512 is to determine the action taken by the user. If the action was to remove one of the blocks, resulting in one block remaining on the baseboard, down branch 520 is followed. If the action was to add a new block, resulting in 3 blocks being on the baseboard, right branch 530 is followed.

If branch 520 is followed, the next step is 522, where the sensors and the microprocessor recognize the remaining letter on the baseboard, either [Char1 ] or [Char2]. At steps 524 and 526, the appropriate phonetic sound for this letter is generated and played over the loudspeaker, just as it was in steps 406 and 408. Subsequently, at step 528, the system goes back to step 410, where there is one block on the baseboard and the system is awaiting further action by the user.

If branch 530 is followed, the next step is 532, where the system determines whether the new block was placed to the left or to the right of the existing blocks on the baseboard, or not adjacent to them. Branch 540 or branch 550 is followed based whether the new block was placed to the left or the right of the existing blocks, respectively.

In branch 540, the next step is 542, in which the system determines the letter [Char3] represented by the new block placed on the baseboard, and recognizes and evaluates the 3-letter sequence [Char3][Char1][Char2]thus formed. At step 544 the proper phonetic sound is generated for this sequence, using a voice algorithm or pre-recorded sounds or a combination thereof; and at step 546 this sound is played on the loudspeaker. Following this sequence of steps, the system is at step 570, where there are 3 blocks on the baseboard and the system is awaiting further action by the user.

In branch 550 the system follows steps 552, 554 and 556, which are identical to steps 542, 544 and 546 of branch 540, except that the letter sequence is [Char1][Char2][Char3] rather than [Char3][Char1][Char2]. As with branch 540, branch 550 leads to step 570, where there are 3 blocks on the baseboard and the system is awaiting the user's next action.

If the new block was determined at step 532 to have been placed in a position not adjacent to the existing blocks, then there are now 3 blocks on the baseboard, but not forming a contiguous sequence. In such a case, the system will perform actions similar to those described above in the situation where the system determines at step 416 that a block has been placed so as to leave a gap between blocks on the baseboard, i.e. the system will generate and play separate sounds for each letter or contiguous letter pair, and/or sound an error code.

At step 570 there are 3 blocks on the baseboard, and the next user action will result in either 2 or 4 blocks being on the board, depending on whether the user removes or adds a block. The next step 580 determines what action the user has taken. Following this determination, if there are 2 blocks remaining on the board, then the system reverts to step 510, and proceeds from there. If there are 4 blocks on the board, then the system follows a similar process to that described above when a 3^{rd} block was added to the baseboard. The process can be repeated for up to the maximum number of blocks that the baseboard can hold: Each time a block is added or removed, the system evaluates the new block, if applicable, and analyzes the sequence of letters represented by the blocks then in the slots on the baseboard, then generates and plays the phonetic sound or sounds represented by such letter sequence.

In some embodiments, the invention comprises, in addition to blocks representing individual letters in the relevant alphabet, blocks representing common combinations of letters in the language being taught, such as “CH” and “TH” in English. In the foregoing discussion of letters represented by blocks, “letters” can also refer to such letter combinations. Thus, for example, [Chart ] could be the combination “CH”, which when placed in sequence with a [Char2] of “A” and a [Char3] of “T” would form the word “CHAT”.

In some embodiments, the invention comprises a “Submit” or similar button on the baseboard unit. This button can be used to instruct the microprocessor to evaluate and play the phonetic sound of the sequence of letters represented by the blocks then in the baseboard unit. In this way the user can hear the pronunciation of the letter sequence repeated upon request, to aid in learning such pronunciation. In some embodiments the button could be labeled “Replay” or something else other than “Submit”. In some embodiments the phonetic pronunciation is not played over the loudspeaker until the user presses the “Submit” button. In some embodiments, when the system is used in “Classroom” mode, described further below, the “Submit” button can be used to submit information about the contents of the baseboard unit to the teacher.

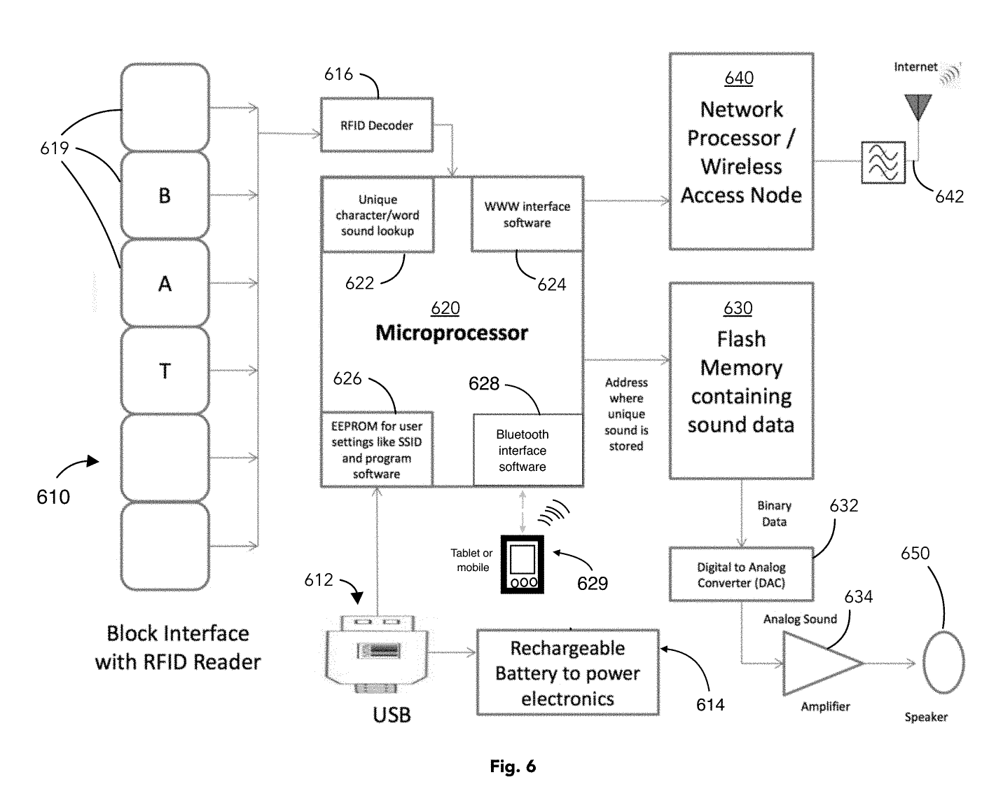

FIG. 6 illustrates, in schematic fashion, circuitry contained in the baseboard unit in an embodiment of the invention. Microprocessor 620 includes EEPROM 626 for storing user settings and system software, software 624 for interfacing with the internet, software 622 to allow lookup of sounds and words, and software 628 for interfacing wirelessly with an external device such as a tablet computer or smartphone 629 using Bluetooth™ or other suitable protocol. The microprocessor is connected to the block interface 610 consisting of sensors 619 located at each of the slots in the baseboard; the sensors are Radio Frequency Identification (RFID) readers, and they are connected to the microprocessor via RFID Decoder 616. This diagram assumes that each block to be used with the baseboard unit contains an RFID tag by which the letter or letters represented by the block can be identified. In other embodiments of the invention, the blocks are identified by bar codes or similar codes printed on the bottom face of each block, and the baseboard unit comprises appropriate hardware, such as bar code scanners, for reading such codes. In other embodiments of the invention, the blocks are identified by optical character recognition (OCR) scanners in the baseboard unit. In yet other embodiments, the blocks are identified by a unique pattern of mechanical and/or electrical contacts embedded in the bottom face of each block, and the slots in the baseboard unit, along with the software in the microprocessor, are configured to detect and identify such patterns.

Connected to the microprocessor 620 is a flash memory unit 630, used to store data corresponding to sounds to be played over the loudspeaker 650, representing such sounds in digital format. These binary data are converted to an analog audio signal by digital-to-analog converter (DAC) 632, and such audio signal is amplified by amplifier 634 on its way to the loudspeaker 650. In some embodiments, the amplifier 634 is connected to a volume control dial, or buttons, or other means by which the user can adjust the volume of the loudspeaker's sound output. In some embodiments, the microprocessor 620 is connected to a speed control dial, or buttons, or other means by which the user can adjust the speed at which sounds are played over the loudspeaker, which can help the user understand, recognize and learn the various phonemes that make up a given word.

In the disclosure herein, the term “microprocessor” is used alternatively to refer to the microprocessor 620 or to the combination of the microprocessor 620 along with the flash memory unit 630, DAC 632, amplifier 634, sensors 619 and/or RFID decoder 616 or other analogous hardware, as the context requires.

The baseboard unit comprises a battery 614 for powering the microprocessor and other electronic components of the apparatus. In some embodiments the battery is rechargeable. In some embodiments the baseboard unit comprises a USB port 612 which is connected to the EEPROM 626. The USB port can be used to load program software and SSID codes into the EEPROM, as well as to charge a rechargeable battery. In other embodiments the EEPROM 626 is connected to a wireless transceiver, such as one using Bluetooth™ protocol, by which the EEPROM can be accessed wirelessly.

The microprocessor is connected to wireless access node (WAN) 640, which is attached to antenna 642. The WAN allows the microprocessor to communicate with the internet and/or with other devices in a local area network, such as when the invention is being used in classroom mode.

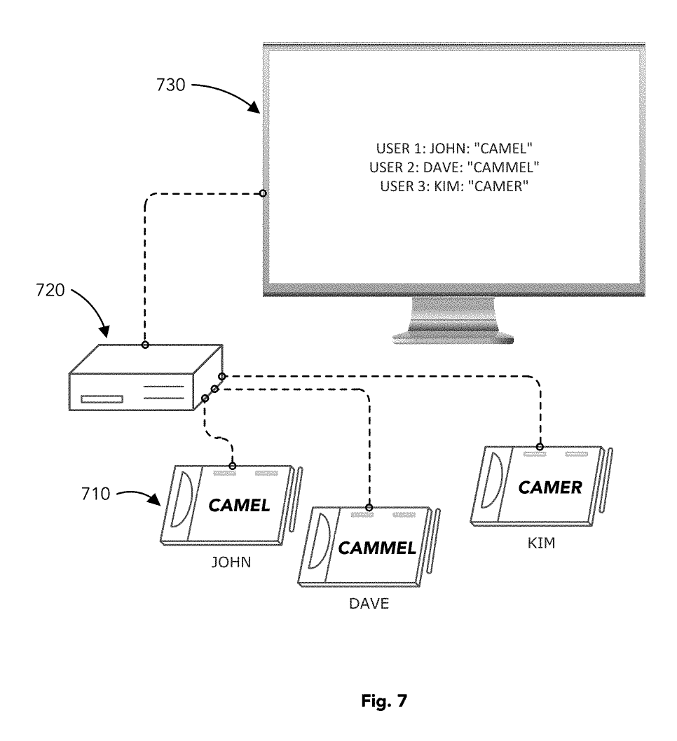

FIG. 7 illustrates in schematic form the use of the invention in classroom mode. Multiple baseboard units 710 are being used concurrently, with each baseboard unit in communication with a central computer 720. Such connection can be wireless using a WAN, Bluetooth™ transceiver or other communications hardware contained in each baseboard unit, or can be through a wired connection such as through a USB or other port in each baseboard unit. The central computer 720 is in communication with a teacher's display device 730, which could be a computer monitor, tablet, smartphone or other display device. Such connection can also be either wired or wireless, and can take place over the internet or over a local network. As shown in FIG. 7, each baseboard user is attempting to spell the same word, “camel”, and the teacher's display shows the teacher in real time what actions are being taken by each user. Other configurations are possible. For instance, different users could be working on different words at the same time. Also, the system can be configured such that the teacher sees what a user has done on his baseboard unit only after the user presses the “submit” button. This configuration could be useful, for instance, when the teacher is administering a test to students using the system. The central computer can record actions taken by each user, and such records can be used to track the progress of students.

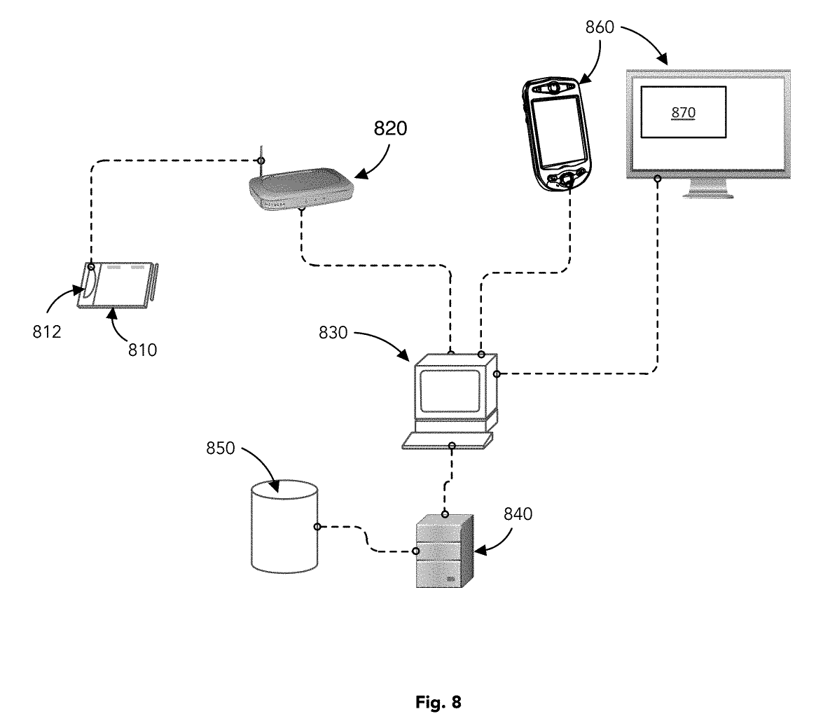

FIG. 8 illustrates schematically an exemplary embodiment of the invention being used in classroom mode, illustrating the computer communication and processing systems utilized. Baseboard unit 810 contains a network processor 812 which wirelessly communicates with wireless router 820, which in turn is connected to the internet and allows multiple such baseboard units 810, each with a network processor 812, to communicate with a web server 830. The web server is programmed using web languages 840 and uses a database 850 for storing data obtained from the baseboards and for other purposes. The teacher's PC or tablet 860 is connected to the web server 830 through the internet. An exemplary screenshot 870 (see 730 in FIG. 7) shows the sort of display the teacher would see when using the invention in classroom mode, here again with multiple users trying to spell the word “camel”.

The baseboard described herein is compatible with a peripheral “Meaning” module that instructs the user via audio or a visual interface as to the meaning of the word that the user input on the baseboard. This module can be enhanced to provide advanced learning options not limited to suggesting examples on how to use the input word in a sentence by giving various examples such as past tense, present tense, etc. This module is also capable of providing choices for synonyms and antonyms and their usage in possible sentence structure.

The baseboard described herein is compatible with a peripheral “Voice Processor” module that records a user's pronunciation of the spelled word via a microphone, processes the input, then provides feedback if the user pronounced the word properly.

The baseboard described herein is compatible with a software interface that enables the capture of user inputs for data management and analysis. Such interface can be used to provide an array of supplemental features including but not limited to tracking user progress, time spent, and identifying areas of improvement.

The baseboard described herein is compatible with possible peripherals to expand features including but not limited to (1) visual displays on the baseboard, (2) a microphone that has ability to record a user voice, (3) earphone plugs (4) interaction with other baseboard using world wide web (4) interaction with existing household products like tablets, smartphones, and television sets, (5) connection with central computer located in a local network or worldwide network.

The baseboard described herein can utilize an externally supplied tablet/smartphone/laptop to leverage computation resources and additional hardware options that such devices offer including but not limited to (1) utilizing the external device's visual display to provide a more engaging experience for the user; for example, if a user placed the letters “cat” on the baseboard, the device's screen would show a image of a cat and provide additional tutorial on the significance of such word; (2) utilizing their screens to recognize letter blocks and accept user inputs, (3) utilizing the functionality of the camera, (4) ability to connect to the internet and other users, (5) ability to utilize voice recognition, (6) ability to run complex algorithms to formulate tests suited for the particular users skill levels.

The baseboard design used for recognizing phonetic input blocks in extends to blocks without a unique identifier embedded in them. A smart screen capable of recognizing contours of known alphabet blocks can be used to determine the letter associated with the block placed on the screen, which then gets processed to generate the appropriate sound.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. An apparatus to aid in language and spelling skills, comprising:
a plurality of physical tokens sized and configured for individual manual manipulation by a user and each corresponding to one or more characters of an alphabet of a language,
wherein each physical token comprises a plurality of facets,
wherein one or more facets of each physical token is inscribed with the respective one or more characters corresponding to said physical token, and
wherein each physical token encodes a decodable identification code unique to the respective one or more characters associated with said physical token;
a processing unit comprising an electrical power source, a microprocessor, a speech synthesizer, a data storage unit, and an audio speaker; and
a baseboard comprising a plurality of sequentially ordered token receptacles, each receptacle sized and configured to couple to any one of said physical tokens,
wherein each receptacle comprises one or more sensors by which the identification code of said physical token may be decoded,
wherein each sensor is in communication with said microprocessor and transmits to said microprocessor a signal indicative of said identification code of a physical token inserted into said receptacle, and
wherein said microprocessor is configured and arranged to determine an ordered combination of characters corresponding to respective physical tokens coupled to the respective token receptacles, and further to generate an audio signal representing a phonetic pronunciation corresponding to said combination of characters.

2. The apparatus of claim 1, said identification codes encoded in readable electromagnetic tags.

3. The apparatus of claim 1, said identification codes encoded in scannable optical markings.

4. The apparatus of claim 1, said identification codes encoded in mechanical features on at least one facet of each physical token.

5. The apparatus of claim 1, said physical tokens comprising blocks of rectangular cuboid shape.

6. The apparatus of claim 1, further comprising a wireless communications unit connected to said processing unit and configured and arranged to send and receive data from and to said apparatus over a communications network.

7. The apparatus of claim 6, wherein the baseboard comprises a unique identification code by which the apparatus can be identified and distinguished from others in an environment where a plurality of such apparatuses are in communication with a server.

8. The apparatus of claim 7, wherein the baseboard further comprises a button activating a switch that signals said microprocessor to form a phonetic sequence through said speech synthesizer and said audio speaker, based on phonemes of the language, said phonetic sequence depending on the one or more physical tokens coupled to respective one or more token receptacles and depending on said ordered sequence of the physical tokens in the token receptacles.

9. The apparatus of claim 1, configured and arranged using machine readable instructions and circuitry so that the apparatus accepts a sound file or a word in the language from an external source and converts said sound file to an audio signal through said audio speaker, representing a word in said language.

10. The apparatus of claim 1, wherein the microprocessor is configured such that each time a physical token is added to or removed from one of the receptacles in the baseboard, the microprocessor will determine what sequence of characters is represented by the physical tokens that are in the receptacles and will produce an audio signal representing a spoken pronunciation of said sequence of characters and will further transmit such audio signal to the audio speaker.

11. The apparatus of claim 1, further comprising a database of valid words, stored in said data storage unit, and wherein the microprocessor is configured such that a combination of characters represented by physical tokens sequentially placed in the receptacles can be evaluated against such database to determine whether such combination represents a valid word in the language, and such that the microprocessor generates a sound to indicate the results of such determination and transmits such sound to the speaker.

12. The apparatus of claim 11, wherein said database further comprises dictionary definitions of said valid words, and wherein the microprocessor is configured to present to a user a dictionary definition corresponding to a correctly-spelled word represented by an ordered sequence of physical tokens coupled to the baseboard in said receptacles.

13. The apparatus of claim 12, further comprising a translation engine capable of translating words of the language into corresponding equivalents in a second language, and wherein the formation of a valid word in the language will cause the microprocessor to transmit the phonetic pronunciation of a corresponding translated word in the second language to the speaker.

14. The apparatus of claim 6, wherein the baseboard unit further comprises a display screen.

15. The apparatus of claim 14, wherein the display screen comprises a touch screen.

16. The apparatus of claim 1, wherein the baseboard unit further comprises an audio port for connecting a set of earphone speakers or other external audio playback apparatus to the baseboard unit.

17. The apparatus of claim 6, wherein the baseboard unit further comprises a microphone capable of recording the voice of the user and/or a port for connecting such a microphone.

18. The apparatus of claim 1, further comprising a network communication circuit adapted to connect said apparatus to a wired or wireless communication network and exchange data over said network.

19. The apparatus of claim 1, further comprising a wireless communication circuit adapted to pair with a smartphone or tablet computer to utilizing their visual displays in order to provide a more engaging experience for the user by showing picture or meaning corresponding to letters placed on the baseboard.

20. A system for instructing language and spelling skills, comprising:
a first learning aid having a processing unit, a communication unit and a baseboard including a plurality of sequential token receptacles, each token receptacle sized and configured to couple to a physical token encoding one of a plurality of characters in a language;
a second learning aid, similarly constructed as said first learning aid;
wherein each of said first and second learning aids are connectable through their respective communication units to a network; and
wherein a server coupled to said network receives data over said network from each of said first and second learning aids indicative of placement of physical tokens into token receptacles of said first and second learning aids such that said server provides data to a supervisory user regarding a language or spelling activity by users of said first and second learning aids.
